(19) United States
(12) Patent Application Publication
(10) Pub. No.: US 2026/0038356 A1
(43) Pub. Date: Feb. 5, 2026

(54) DEDUPLICATION OF MULTI-CHANNEL EMERGENCY RESPONSE REQUEST NOTIFICATIONS

(71) Applicant: RapidSOS, Inc., New York, NY (US)

(72) Inventors: Christopher Joseph Ennis, Kinnelon, NJ (US); Jeffrey Michael Pikor, Denville, NJ (US)

(21) Appl. No.: 18/789,565

(22) Filed: Jul. 30, 2024

(51) Int. Cl. G08B 25/00; G10L 15/26

(52) U.S. Cl. CPC G08B 25/001; G10L 15/26

(57) ABSTRACT

An emergency management system (EMS) may be used to provide and deduplicate multi-channel emergency response requests for an emergency responder application. EMS may receive, from an emergency communications center (ECC), a first emergency response request over a first channel and a second emergency response request over a second channel. The first or second channel may at least partially include over-the-air UHF or VHF dispatch transmissions that may be recorded as audio data. EMS may compare addresses, types of emergencies (e.g., fire, medical, etc.), and/or requested services (e.g., fire, medical, etc.) to determine if the first and second emergency response requests are the same. If the requests are the same, EMS deduplicates the requests so that an emergency responder application displays/provides a combined request (reducing distractions of first responders). Providing multi-channel emergency response requests may enable validation and error correction of requests provided to and by an emergency responder application.

### TECHNICAL FIELD

This disclosure relates generally to emergency management systems, and in particular to providing emergency response request notifications.

### BACKGROUND

The seconds or minutes following an emergency can sometimes determine whether an injured person lives or dies. Getting emergency incident information to emergency responders quickly can help the emergency responders arrive in time to preserve property, reduce the severity of injuries, and save lives. However well intended, over-informing emergency responders may lead to distracting the emergency responders-potentially extending response time.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example system diagram of an emergency response environment that provides deduplication of multi-channel emergency response request notifications, in accordance with embodiments of the disclosure.

FIG. 2 illustrates an example diagram of an emergency response environment that is operable to deduplicate emergency response requests that have been received for transmission to an emergency responder application, in accordance with aspects of the disclosure.

FIG. 3 illustrates an example diagram of an emergency management system (EMS) that is operable to deduplicate emergency response requests received from an emergency communications center (ECC), in accordance with embodiments of the disclosure.

FIG. 4 illustrates a diagram of a process for validating an address using an audio analysis module, in accordance with embodiments of the disclosure.

FIG. 5 illustrates a diagram of a process for providing radio, computer-aided dispatch (CAD), or sensor requests to an emergency responder application, in accordance with embodiments of the disclosure.

FIG. 6 illustrates an example flow diagram of a process for generating sensor-based alerts, in accordance with embodiments of the disclosure.

FIGS. 7A, 7B, 7C, and 7D illustrate example diagrams of user interface (UI) features that an emergency responder application may provide to emergency responder devices, in accordance with embodiments of the disclosure.

FIGS. 8A, 8B, and 8C illustrate example diagrams of records of different types of emergency response requests that may be provided (e.g., pushed) to emergency responder application to enable display of alerts, in accordance with embodiments of the disclosure.

FIG. 9 illustrates a flow diagram of a process for deduplicating emergency response requests for an emergency response application, in accordance with embodiments of the disclosure.

FIG. 10 illustrates a flow diagram of a process for deduplicating emergency response requests for an emergency response application, in accordance with embodiments of the disclosure.

FIG. 11 illustrates a flow diagram of a process for performing error correction of audio data transcriptions using multi-channel emergency response requests, in accordance with embodiments of the disclosure.

FIG. 12 illustrates an example diagram of an emergency response environment, in accordance with embodiments of the disclosure.

FIGS. 13A, 13B, 13C, and 13D illustrate example diagrams of data payloads that may be used to communicate alert information and updates to a first responder application, in accordance with embodiments of the disclosure.

### DETAILED DESCRIPTION

Various aspects of the disclosure include systems, devices, media, algorithms, and methods for deduplication of multi-channel emergency response request notifications (alerts). In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A public emergency services agency may be established to provide a variety of services. A public emergency services agency can include a 911 call center, a railway call center, a primary call center, a secondary call center (e.g., that receives calls from or routes calls to a primary call center), and the like. A public emergency services agency may be referred to as an emergency service provider (ESP) or an emergency communications center (ECC). One type of ESP or ECC is a public safety answering point (PSAP). A PSAP is another name for a 911 call center that receives emergency calls and dispatches emergency responders in response to the emergency (e.g., 911) calls.

As used herein, a first responder may refer to a firefighter, an emergency medical technician, a paramedic, a police officer, a peace officer, an emergency medical dispatcher, a search and rescue team member, a hazardous materials (HazMat) responder, volunteer emergency workers, and/or public health officials. The systems, processes, and overall technologies disclosed herein may be applicable or implemented for one or more of the various types of first responders, despite some specific examples being directed to firefighters and/or medical service providers for illustrative purposes.

About 80% of fire departments are fully or mostly volunteers, and about 80% of the U.S. population is covered by the service of volunteer firefighters and emergency medical first responders. ECCs request the services of the first responders using radio communications. Sometimes, the first responders are in ranges for their handheld radios to receive the radio transmissions. At other times, the first responder stations transmit alerts over pagers to the first responders. More recently, first responders have been able to receive digital alerts over first responder applications that provide notification of the emergency service request, but the first responder applications are not without issue.

When a volunteer first responder receives a notification through their pager or app, they get into “go mode”—a high alert state of training-based procedures to prepare to respond. They are getting dressed, mentally preparing, grabbing gear, walking out the door, getting into vehicles, and leaving family/recreation events to drive to either the fire/medical station or to the scene of the incident. Some emergency responder applications provide alerts from CAD-based communications. Some emergency responder applications provide alerts from radio-based communications (e.g., include an audio recording). Some emergency responder applications provide both CAD-based and radio-based communications, when possible. One of the downsides of providing CAD-based and audio/radio-based alerts is that they do not arrive at a synchronized time-neither is it advantageous to hold back one alert until the other alert is ready. As a result, a first responder using an emergency responder app may receive a radio-based notification of an incident and then several minutes later may receive a CAD-based notification of the same incident. The lack of synchronization could be based on the CAD system or could be based on when a dispatcher sends the CAD-based notification. Regardless, a first responder may be receiving second/duplicative notifications enroute to an emergency. The second notification, even though redundant of the first, can put the first responder in the precarious situation of checking their electronic (e.g., mobile) device for a potential emergency alert while urgently navigating traffic, weather conditions, low-light conditions, etc. If the second notification (through a second channel) is redundant, it would be beneficial not to distract the first responder, unnecessarily.

Embodiments of the disclosure include systems and methods of deduplicating multi-channel emergency response requests for an emergency responder application. Deduplication of multi-channel emergency response requests (and request notifications) can have several advantages. First, the deduplication (and silencing duplicate requests) may reduce distraction of first responders who are already aware of an emergency incident. Second, the multi-channel nature of the duplicative emergency response requests may be used to validate an emergency request alert by indicating to a first responder that the same emergency response request has come through multiple channels. Third, because some channels of communication (e.g., digital CAD) may have more reliable information than, for example, an audio transcription, the disclosed systems and methods may use multi-channel emergency response requests for error correction, according to some embodiments. Accordingly, the technology of the present disclosure may be advantageous to emergency response systems, applications, and personnel.

An emergency management system (EMS) may be used to provide and deduplicate multi-channel emergency response requests for an emergency responder application. The EMS may receive, from an ECC, a first emergency response request over a first channel (e.g., radio-based) and may receive a second emergency response request over a second channel (e.g., CAD-based). The first or second channel may at least partially include over-the-air UHF or VHF dispatch transmissions that may be recorded as audio data. The EMS may compare addresses, types of emergencies (e.g., fire, medical, etc.), and/or requested services (e.g., fire, medical, etc.) to determine if the first and second emergency response requests are the same. If the requests are the same, the EMS deduplicates the requests so that an emergency responder application displays/provides a combined request (reducing distractions of first responders).

Providing multi-channel emergency response requests may enable validation and error correction of requests provided to and by an emergency responder application. In one embodiment, a first emergency response request from a first communications channel may be displayed as a first emergency request alert in an emergency responder application. When a second emergency response request from a second communications channel is received for the same emergency, the first emergency request alert may be updated (e.g., as a combined alert) to indicate that the same request has been received over a second communications channel (e.g., from a CAD system). The update may serve as validation to a first responder for the address and other information received over the emergency responder application.

Similarly, the EMS may use multi-channel emergency response request data to perform error correction, according to embodiments of the disclosure. If the street number or street name of an address do not match between transcribed audio and CAD-based data, the EMS may be configured to update the audio transcribed street number or the audio transcribed street name (but not both). If both the street number and the street name are different, then the EMS may determine that the incident notifications are for two different emergencies and are not to be combined.

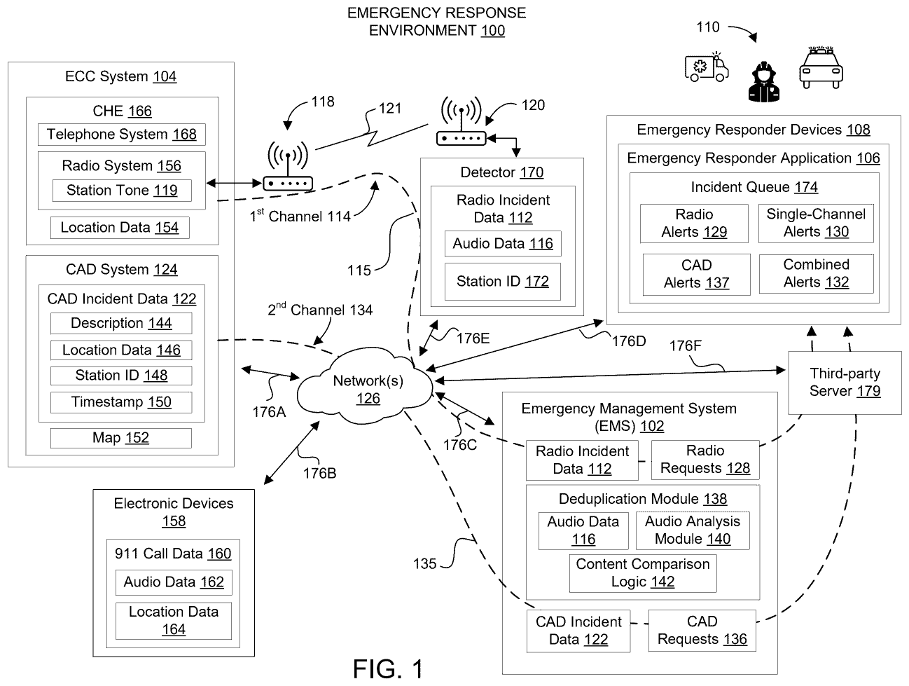

Overall, embodiments of the disclosure improve the technology area of 911 service systems and emergency response systems by improving the reliability of digital notification sent to first responders who are out of radio range from their dispatching ECC. Various embodiments of the disclosure are described hereafter and represented in FIGS. 1-13D.

FIG. 1 illustrates an example system diagram of an emergency response environment 100 that provides deduplication of multi-channel emergency response request notifications, in accordance with aspects of the disclosure. Emergency response environment 100 includes an emergency management system (EMS) 102 that is operable to receive emergency response requests over multiple channels from an ECC system 104 and is operable to provide the emergency response requests to an emergency responder application 106 on emergency responder devices 108 for one or more emergency responders 110, in accordance with aspects of the disclosure. One of the multiple channels may be at least partially based on an over-the-air radio transmission (e.g., in the VHF or UHF bands) from a dispatcher, and another of the multiple channels may at least partially be from a computer aided dispatch (CAD) system 124. Because receiving emergency response requests are inherently distracting to emergency responders, EMS 102 is configured to analyze and deduplicate (e.g., selectively merge) emergency response requests to help reassure first responders that they are not receiving a new/additional request when communications over the first and second channels are received at different times. Deduplication of emergency response requests may include converting a single-channel request into a multi-channel request by modifying/updating the single-channel request to reflect validation/verification of the response request through a second channel. Icons, text, images, or other UI elements may be used in the emergency responder application to represent updates from the second channel, according to various implementations. Advantageously, multi-channel emergency response requests may provide additional validation of single-channel requests and/or may be used to perform error correction of, for example, audio transcriptions of radio transmission, in accordance with aspects of the disclosure.

EMS 102 receives, deduplicates, and provides emergency response requests from multiple channels to support emergency responders 110, in accordance with aspects of the disclosure. EMS 102 is configured to receive radio incident data 112 over a first channel 114. First channel 114 may have a path that extends from ECC system 104 to detector 170, to EMS 102, and to responder devices 108. The first channel 114 at least partially includes radio transmission of audio data 116 from a radio 118 to a radio 120. Radio 118 may be a UHF and/or VHF radio transceiver that is operated by a dispatcher or telecommunicator at an ECC. Radio 120 may be a radio receiver or scanner that is configured to receive audio transmissions from radio 118 over one or more frequencies. Radio incident data 112 includes an over-the-air emergency response request that may initially be an audio recording of a dispatched incident (e.g., represented as audio data 116). Radio incident data 112 may also include a station ID 117 that identifies the one or more stations (e.g., fire station, emergency medical services, etc.). The station ID 117 may be determined based on a station tone 119 used during the radio communications that provide the emergency response request. EMS 102 may analyze/compare radio incident data 112 and CAD incident data 122 to determine if one source of incident data is duplicative of the other. EMS 102 provides radio requests 128 to responder application 106 as single-channel requests 130 or as combined requests 132, in accordance with aspects of the disclosure. EMS 102 may provide radio requests 128 (and CAD requests 136) to responder application 106 through a third-party server 179 (e.g., a telecommunications server, a smartphone manufacturer, an operating system developer, etc.), which forwards the requests to the responder application 106, according to an embodiment. Radio requests 128 may include radio incident data 112 that has been converted to a format (e.g., tagged for a particular naming convention, JSON, XML, transcribed audio, summarized, etc.) for receipt/use by emergency responder application 106.

EMS 102 is configured to receive CAD incident data 122 from a CAD system 124 over one or more networks 126, according to an embodiment. CAD incident data 122 includes, but is not limited to, a description 144, location data 146, a station ID 148, and a timestamp 150, according to embodiments of the disclosure. Location data 146 and/or other CAD incident data 122 may be displayed or otherwise represented on a map 152 of CAD system 124.

EMS 102 may be configured to receive CAD incident data 122 over a second channel 134. The second channel 134 is a CAD-based transmission/reception of an emergency request response, according to an embodiment. EMS 102 may support a number of application programming interfaces (APIs) that enable CAD system 124 to transmit/receive incident data for emergency response requests. The second channel 134 includes a data path 135 that extends from CAD system 124, extends to EMS 102 through one or more networks 126, and extends to emergency responder application 106 on emergency responder devices 108, according to an embodiment. CAD incident data 122 includes an emergency response request (e.g., inclusive of description 144, location data 146, and/or station ID 148) that may initially become available from CAD system 124 and be dispatched electronically to, for example, EMS 102. EMS 102 may evaluate radio incident data 112 and CAD incident data 122 and selectively deduplicate requests into combined requests 132. Based on CAD incident data 122, EMS 102 generates and/or provides CAD requests 136 to responder application 106 as single-channel requests 130 or as combined requests 132, in accordance with aspects of the disclosure. CAD requests 136 may include CAD incident data 122 that has been converted to a format (e.g., JSON, XML, etc.) for receipt/use by emergency responder application 106.

EMS 102 may include a deduplication module 138 to support deduplication operations, according to an embodiment. Deduplication module 138 may include an audio analyzer 140 and content comparison logic 142. Deduplication module 138 may be configured to apply audio data 116 to audio analyzer 140 to determine the content of audio data 116. Audio analyzer 140 may be implemented as a transcription tool, a transcription service, a large language model (LLM), and/or as an artificial intelligence (AI) model, in accordance with various aspects of the disclosure.

Deduplication module 138 may use content comparison logic 142 to compare the content of radio incident data 112 with the content (e.g., description 144, location data 146, station ID 148) of CAD incident data 122, according to an embodiment. Content comparison logic 142 may compare addresses, station IDs, type of emergency, and/or timestamp data to determine that CAD incident data 122 is a duplicate of radio incident data 112 (or vice-versa), according to embodiments of the disclosure. If radio incident data 112 is not a duplicate of CAD incident data 122, EMS 102 may be configured to provide radio requests 128 and CAD requests 136 as single-channel requests that responder application 106 may display as single-channel alerts 130. If radio incident data 112 is duplicative of CAD incident data 122, EMS 102 may be configured to provide combined (multi-channel) requests that responder application 106 may display as combined alerts 132. In one embodiment, EMS 102 and/or emergency responder application 106 modifies one of the single-channel alerts 130 with additional incident data to create one or more of the combined alerts 132, according to an embodiment. EMS 102 and/or emergency responder application 106 may be configured to temporarily suppress notification alarms or sounds in responder application 106 when generating one or more combined alerts 132, to reduce the likelihood of distracting an emergency responder, according to an embodiment.

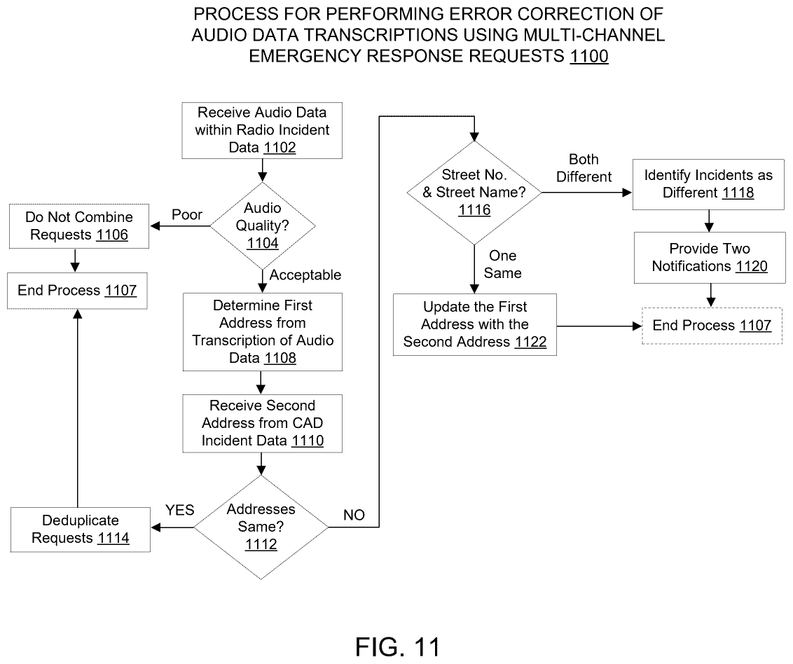

Combined alerts 132 may be implemented as updated or modified versions of single-channel alerts 130. In one implementation, EMS 102 creates one of combined alerts 132 by updating/replacing data from one of radio request 128 with at least some information from one of CAD requests 136. For example, a particular one of combined requests 132 can include an initial radio request (i.e., radio-based emergency response request) that identifies location data 154 of an incident (e.g., residential fire) and a description of the incident. The particular one of combined alerts 132 can be generated or updated to include a CAD symbol or indication that the emergency response request has also been delivered by a CAD system 124 (e.g., via a second communications channel). The opposite may be true, in that one of combined alerts 132 can include data from CAD requests 136 (i.e., CAD-based emergency response request) that identifies location data 146, description 144, station ID 148, and timestamp 150. The combined alert can be updated to include content from radio incident data 112, such as: a link to an audio recording (e.g., audio data 116) of the dispatch; or a radio symbol or indication that the emergency response request has also been delivered by, for example, radio system 156. Receiving emergency response requests over multiple channels provides validation to emergency responders of electronic notifications of emergency incidents-which is a non-traditional medium of communication for the profession. Multi-channel emergency response requests may also be used for error correction, for example, as described in FIG. 11 and the corresponding disclosure.

Emergency response requests may be initiated with electronic devices, according to an embodiment. Electronic devices 158 represent smart phones, smart watches, tablets, laptops, computer systems, or the like. Electronic devices 158 may initiate an emergency response request with a 911 call (i.e., an emergency call). Electronic devices 158 may then provide 911 call data 160 to ECC system 104 using one or more cellular networks or other networks 126. The 911 call data 160 may include audio data 162 and location data 164. The audio data 162 is representative of the information a caller audibly (or text-based) provides to ECC system 104 during, for example, a conversation with a telecommunicator, in one embodiment. The location data 164 may represent device-based location data (e.g., GPS, other satellite network, wireless router location, etc.) or may represent automated location information (ALI) data that is at least partially generated/provided by a cellular tower as an estimated location of an electronic device.

ECC system 104 provides tools for call-takers, dispatchers, or other telecommunicators to interact with emergency number callers (e.g., users of electronic devices 158). ECC system 104 may include call handling equipment (CHE) 166 and CAD system 124 to support delivery of emergency response requests to responder devices 108. CHE 166 may include a telephone system 168 and radio system 156 (inclusive of radio 118) for receiving 911 call data 160 and for communicating radio incident data 112, according to an embodiment. Telephone system 168 may include one or more landlines and one or more voice over IP (VOIP) lines. A telecommunicator may use radio system 156 to broadcast an over-the-air emergency response request to one or more emergency responders 110. As part of dispatching an over-the-air emergency response request, radio system 156 may emit a station tone 119 and audio data 116 with radio 118 over ultra-high frequency (UHF) and/or very-high frequency (VHF) bandwidths. Station tones can be associated with one or more particular stations or types of emergency responders 110 (e.g., firefighter, emergency medical services, police officers, etc.). For example, within a county a first fire station may be assigned or associated with a first tone sequence, a second fire station may be assigned or associated with a second tone sequence, and all fire stations within the county may be assigned/associated with a third tone sequence. In the same county, a first emergency medical service (e.g., emergency medical technicians (EMTs)) station may be assigned a fourth tone, a second emergency medical service station may be assigned a fifth tone sequence, and the first fire station and the second emergency service station may be assigned a sixth tone sequence, for example. In some counties, a fire station may also serve as an emergency medical service station, so the station may be associated with a single tone sequence or three separate tone sequences, for example.

CAD system 124 may be used in parallel with CHE 166 by telecommunicators to provide emergency response requests to emergency responders 110. CAD system 124 may automatically receive at least part of CAD incident data 122 (e.g., location data 146) from EMS 102 or other emergency data providers, according to one embodiment. CAD system 124 may also receive CAD incident data 122 by a dispatcher or telecommunicator that enters the content of audio data 162 into CAD system 124. CAD incident data 122 includes description 144, location data 146, station ID 148, and timestamp 150. Description 144 may include the type of incident, people involved in the incident, a description of injuries, and the like. Location data 146 may include an address, descriptive location, and/or latitude/longitude coordinates to an incident. The term “address” may be used interchangeably with “descriptive location”. An address or descriptive location may include a street address, a general location, and/or a street address combined with a description or address modifier, such as: in front of 123 Main Street, across the street from 234 Second Street, southwest of the residence on 345 Third Street, on the north end of Bay View Park, etc. Station ID 148 may include an identifier of one or more fire stations or emergency medical services stations that are near the location of an incident or that have jurisdictional responsibility for the location of the incident. The timestamp 150 may provide a date and time for when a call was made to 911 or may refer to when CAD incident data 122 was entered into CAD system 124.

Emergency response environment 100 may include detector 170 that is operable to digitally capture (analog audio) information provided by radio 118 and received by radio 120, according to an embodiment. Detector 170 may be communicatively coupled to radio 120, and radio 120 may be strategically located where radio waves 121 may be detected from radio 118 (e.g., away from a station or home of an emergency responder). Detector 170 may be configured to generate radio incident data 112 based on the information provided with radio system 156. Radio incident data 112 may include audio data 116 and station ID 172. Audio data 116 may be a recording (in a digital format) of an emergency response request that was transmitted/dispatched using radio 118. Station ID 172 may be determined by detector 170 based on the station tone 119 transmitted by radio system 156/radio 118. In one embodiment, radio 120 and detector 170 are aspects of EMS 102, according to an embodiment.

Emergency responder application 106 enables the emergency responders 110 to receive emergency response requests when transmissions from radio system 156 do not or cannot reach one or more responder devices 108 (e.g., responder radios). For example, emergency responders 110 may carry handheld radios tuned to the frequency of radio 118. However, their handheld radios may be located too far away from radio 118 to receive audio data 116 over-the-air. Especially in rural and mountainous regions, radio waves 121 from radio 118 may struggle to propagate to responder devices 108. Advantageously, emergency responder application 106 is operable to receive radio requests 128 based on radio incident data 112 and is operable to display radio requests 128 as radio alerts 129 for visibility and interaction by emergency responders, according to an embodiment. Additionally, emergency responder application is operable to receive CAD requests 136 that are based on CAD incident data 122 and is operable to display CAD requests 136 as CAD alerts 137, according to an embodiment. Emergency responder application 106 may enable emergency responders 110 to receive emergency response requests using an Internet connection (e.g., a Wi-Fi connection, a satellite connection, a cellular connection, a fiber optics modem, a landline modem, etc.) at their home, station, or while away from their home and station. Emergency responder application 106 can include an incident queue 174 that displays single-channel alerts 130 and/or combined (multi-channel) alerts 132 to enable emergency responders 110 to view, organize, and respond to emergency response requests, according to an embodiment. Emergency responder devices 108 may include, but are not limited to, mobile phones, watches, pagers, tablets, laptops, in-dash vehicle systems (e.g., screens), or the like.

Networks 126 may be communicatively coupled to various components of emergency response environment 100 using a number of communications channels 176. For example, a communications channel 176A may communicatively couple ECC system 104 to the one or more networks 126. A communications channel 176B may communicatively couple electronic devices 158 to the one or more networks 126. A communications channel 176C may communicatively couple EMS 102 to the one or more networks 126. A communications channel 176D may communicatively couple responder devices 108 to the one or more networks 126. A communications channel 176E may communicatively couple detector 170 to the one or more networks 126, for example. A communications channel 176F may communicatively couple EMS 102 and/or electronic devices 158 to third-party server 179. Communications channels 176A, 176B, 176C, 176D, 176E, and 176F may be collectively referred to as communications channels 176, which may enable the various components of emergency response environment 100 to communicate with each other.

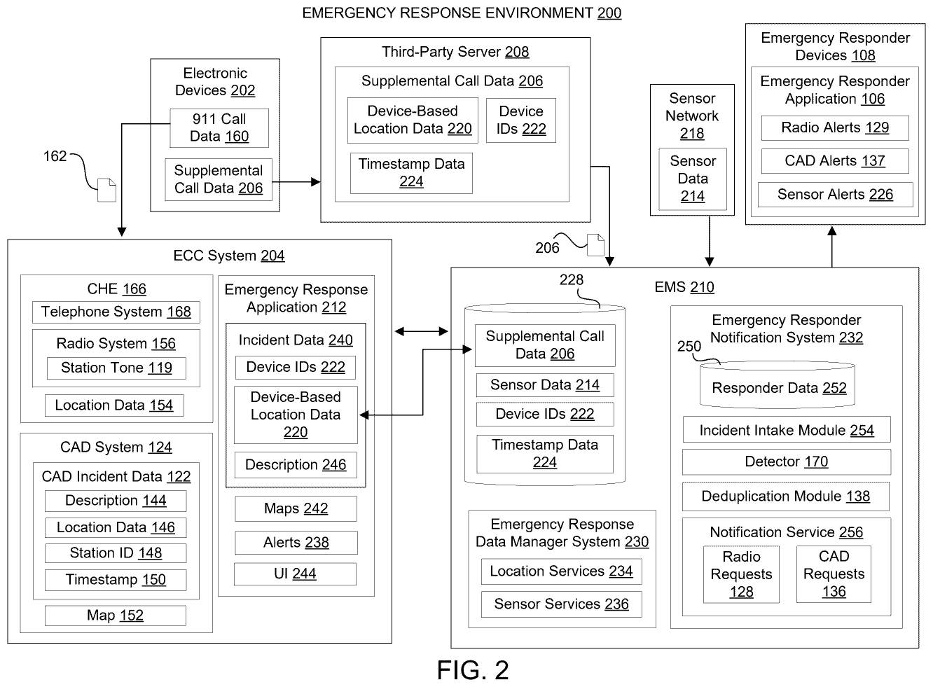

FIG. 2 illustrates an example diagram of an emergency response environment 200 that is operable to deduplicate emergency response requests that have been received for transmission to an emergency responder application 106, in accordance with aspects of the disclosure. Emergency response environment 200 is an example implementation of emergency response environment 100 (shown in FIG. 1). Emergency response environment 200 includes electronic devices 202 that provide audio data 162 to an ECC system 204, according to an embodiment. The electronic devices 202 also include supplemental call data 206 that is provided to a third-party server 208, and at least part of supplemental call data 206 is provided to an EMS 210 that is operable to provide at least part of supplemental call data 206 to an emergency response application 212, according to an embodiment.

Emergency response environment 200 is operable to support the use of supplemental call data 206 and sensor data 214 in both ECC system 204 and emergency responder application 106, in accordance with aspects of the disclosure. Emergency response environment 200 may include a third-party server 208 and a sensor network 218. Third-party server 208 may be operable to receive and provide supplemental call data 206, and sensor network 218 may be operable to provide sensor data 214, according to an embodiment. Third-party server 208 represents one or more of a telecommunications company, a smart phone manufacturer, or a mobile device operating system developer that accesses or receives supplemental call data 206 (e.g., device-based location data) from electronic devices 202 when a 911 call is initiated on or from electronic devices 202. The third-party can cause electronic devices 202 to provide supplemental call data 206 by including such functionality in firmware for the device or in one or more software modules in an operating system for the electronic devices 202. Supplemental call data 206 may include device-based location data 220, device IDs 222, and timestamp data 224, according to an embodiment. Device-based location data 220 includes, but is not limited to, GPS data, other satellite data, network connections (e.g., location based on a nearby Wi-Fi network), or the like. Device-based location data 220 represents a location that comes from electronic devices 202 rather than a location that is derived from a cell phone tower. Device IDs 222 represent telephone numbers, media access control (MAC) addresses, or some other identifier for the one or more electronic devices 202 that initiate a 911 call. Timestamp data 224 includes periodic timestamps for the transmission or receipt of supplemental call data 206 and may represent a timestamp at the electronic devices 202 or at the third-party server 208.

Sensor network 218 represents residential buildings, commercial buildings, personal medical devices, personal safety devices, industrial structures, vehicles, crash detectors, smoke alarms, fire alarms, smart cameras, home security devices, moisture detectors, motion detectors, shock detectors, location sensors, gas detectors, pressure sensors, or the like, according to various embodiments of the disclosure. Sensor network 218 may include manufacturers of the sensors that first receive sensor data 214 prior to forwarding sensor data 214 to EMS 210. Sensor network 218 may also include one or more monitoring agencies that receive sensor data 214 (e.g., fire alarm data) and who verify an alarm at a premises prior to forwarding sensor data 214 to EMS 210, according to an embodiment.

EMS 210 receives and uses supplemental call data 206 and/or sensor data 214 to enhance operations of ECC system 204 and of emergency responder application 106, according to an embodiment. In particular, EMS 210 may be operable to provide supplemental call data 206 and/or sensor data 214 to emergency response application 212 to improve the data that is available to a telecommunicator while dispatching emergency responders to an incident. EMS 210 may also use supplemental call data 206 and sensor data 214 to support sensor alerts 226 on emergency responder application 106. Sensor alerts 226 may be used to notify emergency responders of potential incidents even prior to an incident being dispatched from ECC system 204. Sensor alerts 226 include a notification of an emergency response request that is based on sensor data 214 and that may be supplemented or validated by supplemental call data 206 (e.g., validated by an emergency call occurring in the vicinity (e.g., within 500 meters) of the trigger (e.g., a smoke detector, fire alarm, defibrillator, heart-rate monitor, etc.) for sensor data 214, according to an embodiment.

EMS 210 includes a data structure 228, a data manager system 230, and an emergency responder notification system 232, to support operations of emergency response application 212 and emergency responder application 106, in accordance with aspects of the disclosure. Data structure 228 may be implemented as a database, a table, or some other data organization system for storing/maintaining supplemental call data 206 and sensor data 214.

Data manager system 230 may use supplemental call data 206 to support location services 234 and may use sensor data 214 to support sensor services 236 to emergency response application 212 and/or to emergency responder application 106. Location services 234 may include receiving supplemental call data 206 and providing device-based location data 220 for particular device IDs 222 (e.g., telephone number) to emergency response application 212 to enable a telecommunicator to visualize a location of an incident with more accuracy than is traditionally available through 911 call data 160. Data manager system 230 may use device-based location data 220 and device IDs 222 to generate alerts 238 for display in UI 244 of emergency response application 212. Location services 234 may also include providing device-based location data 220 to emergency responder notification system 232 to support providing sensor alerts 226, according to an embodiment.

Data manager system 230 may also provide sensor services 236. Sensor services 236 may include receiving sensor data 214, categorizing the nature of an incident based on sensor data 214 (e.g., fire, trespass, burglary), and associating sensor data 214 with supplemental call data 206. Sensor services 236 may include providing a portion of sensor data 214 to emergency response application 212 as alerts 238, according to an embodiment. Sensor services 236 may include providing a portion of sensor data 214 to emergency responder notification system 232 to support delivery of sensor data to support sensor alerts 226 in emergency responder application 106, according to an embodiment.

Emergency responder notification system 232 may be implemented as one or more software modules and/or as a sub-system of EMS 210 that operates to gather emergency response requests from ECC system 204 and to provide the emergency response requests as radio requests 128, CAD requests 136, and sensor requests to emergency responder application 106, in accordance with aspects of the disclosure. Emergency responder notification system 232 includes a data structure 250 for responder data 252, an incident intake module 254, detector 170, deduplication module 138, and a notification service 256, according to an embodiment. Responder data 252 includes user accounts, station IDs, station tone sequences, contact information, and contact lists for each station. Responder data 252 may also include boundary data that associates addresses with particular first responder stations. Data structure 250 may be configured to associate one or more data types (e.g., user accounts, station IDs, etc.) with each other to facilitate identification of contact lists for incident response requests directed to a particular station, for example. Emergency responder notification system 232 may use responder data 252 to determine who (e.g., which contact list) to send notifications to for a particular station ID or address.

Incident intake module 254 may be operable to facilitate the ingestion of radio incident data 112, CAD incident data 122, sensor data 214, and supplemental call data 206. Incident intake module 254 may be associated with and may receive incident data through various application programming interfaces (APIs) that are provided/supported by emergency responder notification system 232 and that are used by detector 170 and/or CAD systems (e.g., CAD system 124) to provide incident data to EMS 210. Incident intake module 254 may provide incident data to deduplication module 138 for processing. Notification service 256 may include one or more processes for providing (e.g., pushing) radio requests 128, CAD requests 136, and sensor data 214 out to emergency responder application 106 and responder devices 108.

ECC system 204 is an example implementation of ECC system 104 (shown in FIG. 1). ECC system 204 may include the features of ECC system 104 and may additionally include emergency response application 212, according to an embodiment. Emergency response application 212 may be configured to provide incident data 240 that is based on supplemental call data 206 and/or sensor data 214, according to an embodiment. Incident data 240 may include device IDs 222, one or more maps 242, and device-based location data 220 that is displayed on maps 242 to provide telecommunicators with device-based location accuracy. Emergency response application 212 may include a user interface 244 that associates device IDs 222 with device-based location data 220 and enables telecommunicators to interact with users of electronic devices 202 through, for example, text-based messaging, video-based communications, image sharing, and the like. Emergency response application 212 includes a description 246 that may (briefly) provide information about the nature of a particular incident (e.g., fire, medical, burglary, train derailment, etc.). Emergency response application 212 also includes alerts 238 that may be provided by EMS 210 to notify telecommunicator of an incident based on supplemental call data 206 and/or sensor data 214 concurrently with or prior to receiving a 911 call associated with the particular incident.

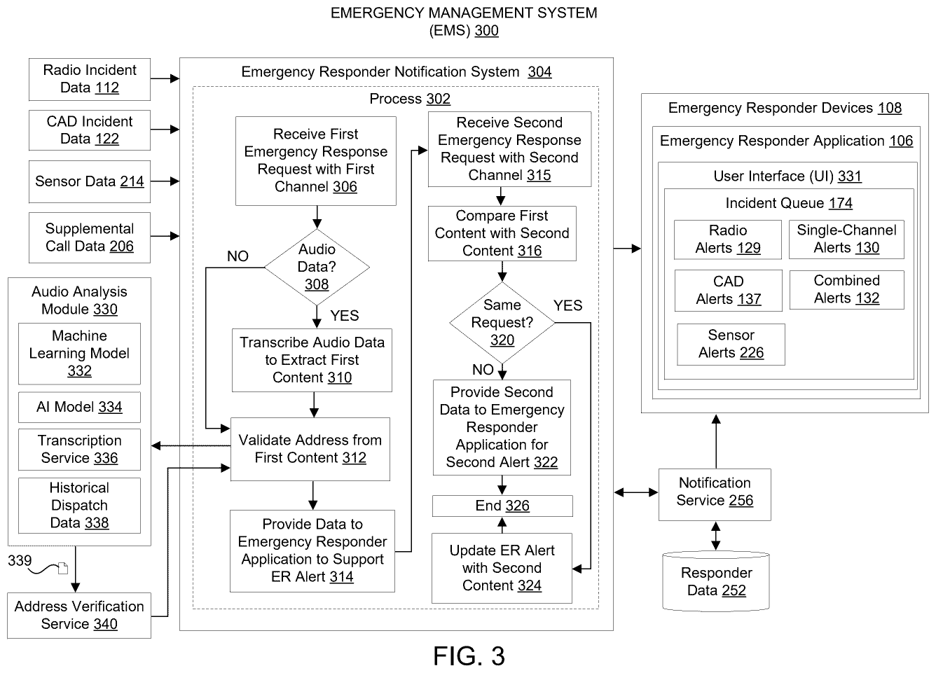

FIG. 3 illustrates an example diagram of an EMS 300 that is operable to deduplicate emergency response requests received from an ECC, in accordance with aspects of the disclosure. EMS 300 is an example implementation of EMS 102 and/or EMS 210, according to embodiments. EMS 300 may run a process 302 in/with an emergency responder notification system 304. Emergency responder notification system 304 is an example implementation of emergency responder notification system 232 and may include the features of emergency responder notification system 232, according to an embodiment. Emergency responder notification system 304 may be organized as one or more software modules including one or more processes, such as process 302. Process 302 and/or emergency responder notification system 304 transform input data (radio incident data 112, CAD incident data 122, sensor data 214, and/or supplemental call data 206) into single-channel alerts 130 and/or combined alerts 132 (e.g., radio alerts 129, CAD alerts 137, sensor alerts 226) in emergency responder application 106, according to an embodiment.

Process 302 may include a number of operations for deduplicating emergency response requests, in accordance with aspects of the disclosure. The order in which some or all of the process operation blocks appear in process 302 should not be deemed limiting. Rather, one of ordinary skill in the art having the benefit of the present disclosure will understand that some of the process blocks may be executed in a variety of orders not illustrated, or even in parallel. The operations of process 302 may be performed by a particular module (e.g., emergency responder notification system 304) or may be distributed between various subsystems or modules in EMS 300, according to various embodiments.

At operation 306, process 302 receives a first emergency response request with a first channel, according to an embodiment. The first emergency response request may be received from radio incident data 112, CAD incident data 122, or sensor data 214. The first emergency response request may be converted or transformed into one of radio requests 128, one of CAD requests 136, and/or one of sensor alerts 226. Radio incident data 112 may include incident data that was at least partially recorded with a detector that is coupled to a scanner to receive a radio-based dispatch from an ECC.

At operation 308, process 302 determines if the first emergency response request includes audio data, according to an embodiment. If the first emergency response request does not include audio data, operation 308 proceeds to operation 312, according to an embodiment. If the first emergency response request includes audio data, operation 308 proceeds to operation 310, according to an embodiment. Audio data may include/represent recording of a dispatch of an incident that is captured by the detector and provided to EMS 300.

At operation 310, process 302 transcribes audio data to extract first content, according to an embodiment. The first content includes transcribed audio from the audio data and is representative of a transcription of the first emergency response request that was provided, that was dispatched over the radio from an ECC. One or more transcription engines or services (e.g., Dragon Naturally Speaking, Otter.ai, Rev.com, Trint, etc.) that may or may not leverage an artificial intelligence (AI) model may be used to transcribe the audio, in accordance with various implementations of the disclosure.

At operation 312, process 302 validates an address from the first content, according to an embodiment. To validate the address from the first content, operation 312 includes applying the first content to an audio analysis module 330 and to an address verification service 340, according to an embodiment. Audio analysis module 330 may be used to determine an address from transcribed audio data (e.g., from operation 310). Audio analysis module 330 may include a machine learning model 332, an AI model 334, and/or a transcription service 336—each of which may be trained on historical dispatch data 338, according to an embodiment. In some implementations, transcription service 336 may include a machine learning model 332 and/or AI model 334, such as Dragon Naturally Speaking, Otter.ai, Sonicx.ai, Descript, Verbit, and/or Google services. For example, Google Cloud Natural Language service or Google Cloud Speech-to-Text service may enable training of sentiment classification, extraction, and detection by uploading training data, for example. Audio analysis module 330 may be prompted or configured to extract an address from the first content that has been transcribed from the audio data. Example prompts may include “determine an address from this text,” for example. Audio analysis module 330 may provide a proposed address 339 to address verification service 340 for validation. Address verification service 340 may include one or more commercially available address verification services, such as, but not limited to, Google address verification, Apple maps, ETSi maps, or the like.

Those skilled in the art understand that machine learning comprises a branch of artificial intelligence. Machine learning typically employs learning algorithms such as Bayesian networks, decision trees, nearest-neighbor approaches, and so forth, and the process may operate in a supervised or unsupervised manner as desired. Deep learning (also sometimes referred to as hierarchical learning, deep neural learning, or deep structured learning) is a subset of machine learning that employs networks capable of learning (typically supervised, in which the data consists of pairs (such as input data and labels) and the aim is to learn a mapping between the input data and the associated labels) from data that may at least initially be unstructured and/or unlabeled. Deep learning architectures include deep neural networks, deep belief networks, recurrent neural networks, and convolutional neural networks. Many machine learning algorithms (e.g., AI algorithms) build a so-called “model” (e.g., an AI model) based on sample data, known as training data or a training corpus, in order to make predictions or decisions without being explicitly programmed to do so. A variety of different methodologies and models may be employed with these teachings, such as those disclosed herein.

In one implementation, audio analysis module 330 iteratively identifies and proposes a potential address from the transcribed audio data. Audio analysis module 330 may search for key terms such as location, located at, at, and/or address. Audio analysis module 330 may then define 3-5 words that follow the key term or that precede the key term to be a potential address or location. Although the term “address” is used to reference the location of an emergency, address may also include relative descriptors such as, “across the street from”, “half a mile north of”, “the south-west corner of”, “behind the building located at”, or the like. Audio analysis module 330 may provide the potential or proposed address 339 to address verification service 340. Of the one or more proposed addresses, audio analysis module 330 may select or return the verified or valid address as the address associated with the transcribed audio data, according to an embodiment.

At operation 314, process 302 provides data to an emergency responder application to support emergency responder alerts, in accordance, according to an embodiment. The data may be in the form of single-channel alerts 130 and may include radio requests 128, CAD requests 136, and/or sensor data 214, according to an embodiment. Alerts of various types may be displayed in one or more current and past alert queues in a user interface (UI) 331 of emergency responder application 106, according to an embodiment.

At operation 315, process 302 receives a second emergency response request with a second channel, according to an embodiment. The second emergency response request may include second content that is in a digital text format. If the second emergency response request includes audio data, operation 315 may return to operation 310, according to an embodiment. The second channel may be a radio-based channel, a CAD-based channel, or a sensor-based channel, according to an embodiment.

At operation 316, process 302 compares the first content with second content from a second emergency response request, according to an embodiment. Comparing the first content with the second content may include, but is not limited to, comparing addresses for an incident, comparing the nature of the emergency (e.g., fire, medical, etc.), comparing a timestamp of the emergency incident (e.g., to be within 30 minutes of each other), for example.

At operation 320, process 302 determines if the first emergency response request is the same as the second emergency response request, according to an embodiment. If aspects of the first content match or correlate with aspects of the second content, then process 302 determines that the requests are for the same incident. If the first emergency response request is duplicative of the second emergency response request, operation 320 proceeds to operation 324, according to an embodiment. If the requests are not for the same incident (e.g., addresses are different and/or nature of emergency is different), operation 320 proceeds to operation 322, according to an embodiment.

At operation 322, process 302 provides a second data to emergency responder application 106 for a second (single-channel) alert, according to an embodiment. Providing the second notification may include providing a second single-channel request 130, as opposed to generating a combined request 132, according to an embodiment. Operation 322 may proceed to operation 326 to end process 302, according to an embodiment.

At operation 324, process 302 may update the emergency responder alert with the second content, according to an embodiment. Updating the emergency responder alert includes converting one of the single-channel requests 130 into one of the combined requests 132, according to an embodiment. Updating the emergency responder alert with second content may include updating the initial alert data to reflect that a second emergency response request was received from one or more of radio incident data 112, CAD incident data 122, or sensor data 214 that validates the first emergency response data, according to an embodiment. Operation 324 may proceed to operation 326 to end process 302, according to an embodiment.

Operations 314 and 324 may include providing incident data to a notification service 256, which may be used, to generate to provide radio requests 128, CAD requests 136, and/or sensor data 214, based on responder data 252 (e.g., inclusive of recipients, contact information, addresses, station ID, user accounts, etc.), for example.

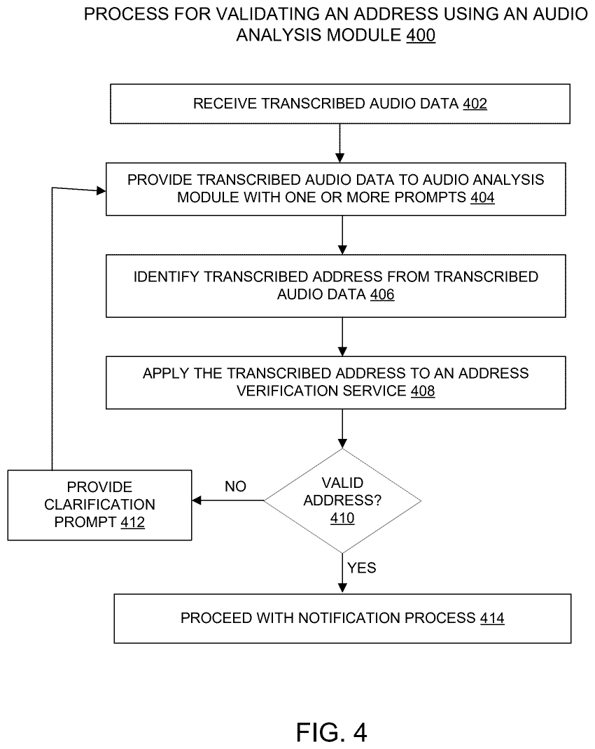

FIG. 4 illustrates a diagram of a process 400 for validating an address using an audio analysis module, in accordance with aspects of the disclosure. The order in which some or all of the process operation blocks appear in process 400 should not be deemed limiting. Rather, one of ordinary skill in the art having the benefit of the present disclosure will understand that some of the process blocks may be executed in a variety of orders not illustrated, or even in parallel. The operations of process 400 may be performed by a particular module (e.g., emergency responder notification system 304) or may be distributed between various subsystems or modules in an EMS, according to various embodiments.

At operation 402, process 400 receives transcribed audio data, according to an embodiment.

At operation 404, process 400 provides transcribed audio data to an audio analysis module with one or more prompts, according to an embodiment. An example of the one or more prompts may include “determine an address from the following text,” for example.

At operation 406, process 400 identifies the transcribed address from the transcribed audio data, according to an embodiment.

At operation 408, process 400 applies the transcribed address to an address verification service, according to an embodiment.

At operation 410, process 400 determines whether the transcribed address is a valid address, according to an embodiment. If the address is not a valid address, operation 410 proceeds to operation 412, according to an embodiment. If the transcribed address is a valid address, operation 410 proceeds to operation 414, according to an embodiment.

At operation 412, process 400 provides a clarification prompt and re-applies the transcribed audio data to the audio analysis module, according to an embodiment. A clarification prompt may include “re-analyze the following text to determine if another address is included in the text,” for example. Operation 412 may proceed to operation 404, according to an embodiment.

At operation 414, process 400 proceeds with the notification process, according to an embodiment. The notification process may include process 500, notification service 502, and/or notification service 256, according to embodiments.

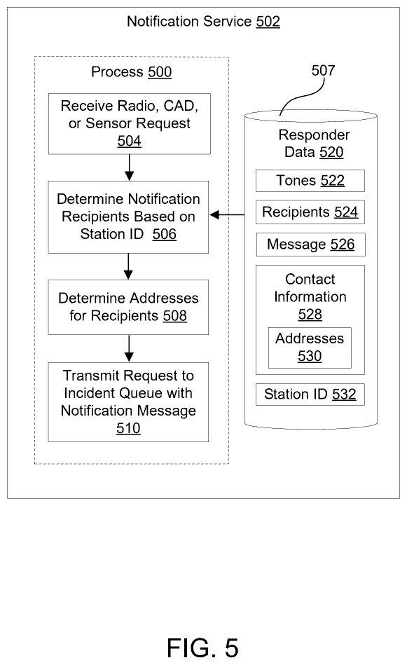

FIG. 5 illustrates a diagram of a process 500, for providing radio, CAD, or sensor requests to an emergency responder application, in accordance with aspects of the disclosure. Process 500 may be performed by notification service 502, according to an embodiment. Notification service 502 is an example implementation of notification service 256, according to an embodiment. The order in which some or all of the process operation blocks appear in process 500 should not be deemed limiting. Rather, one of ordinary skill in the art having the benefit of the present disclosure will understand that some of the process blocks may be executed in a variety of orders not illustrated, or even in parallel. The operations of process 500 may be performed by a particular module (e.g., emergency responder notification system 304) or may be distributed between various subsystems or modules in an EMS, according to various embodiments.

At operation 504, process 500 receives radio, CAD, or sensor requests, according to an embodiment.

At operation 506, process 500 determines notification recipients based on a station ID, according to an embodiment. Process 500 may determine notification recipients by querying a database 507 for responder data 520, according to an embodiment. Responder data 520 may include tones 522 (e.g., two-tone sequence assignments for particular stations), recipients 524, messages 526, contact information 528, addresses 530 (e.g., IP addresses, or mobile app identifier for notification distribution), and/or station IDs 532.

At operation 508, process 500 determines addresses for recipients, according to an embodiment. Addresses 530 may be determined by querying the database 507 for contact information 528 for particular recipients 524, according to an embodiment.

At operation 510, process 500 transmits a request to an incident queue with a notification message, according to an embodiment. The incident queue may be a list of current and/or past incidents in an emergency responder application. The notification message may be a sound or a visual notification that pops up to alert a user of a new request, according to an embodiment.

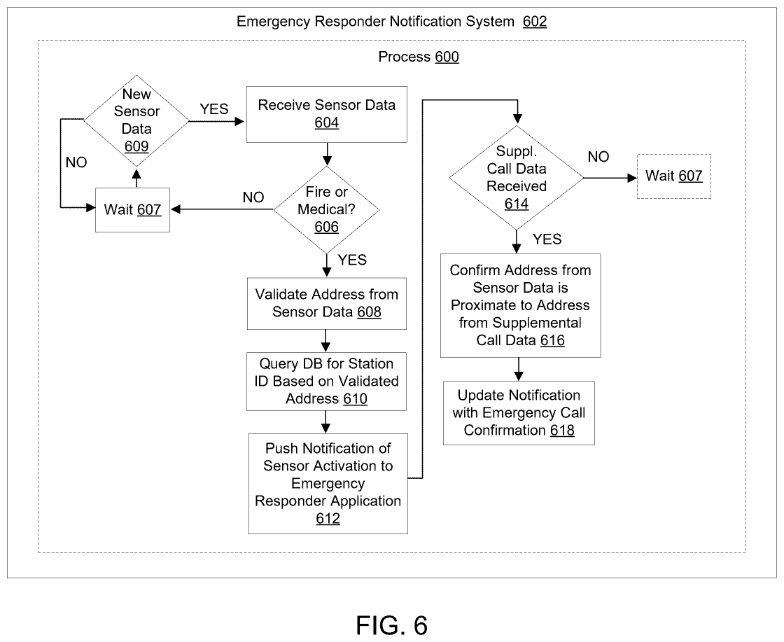

FIG. 6 illustrates an example flow diagram of a process 600 for generating sensor-based alerts, in accordance with aspects of the disclosure. Process 600 may be performed by emergency responder notification system 602 or one or more other components of an emergency management system, according to an embodiment. Emergency responder notification system 602 may be implemented as one or more software modules having instructions that include the operations of process 600. The order in which some or all of the process operation blocks appear in process 600 should not be deemed limiting. Rather, one of ordinary skill in the art having the benefit of the present disclosure will understand that some of the process blocks may be executed in a variety of orders not illustrated, or even in parallel. The operations of process 600 may be performed by a particular module or may be distributed between various subsystems or modules in an EMS, according to various embodiments.

At operation 604, process 600 receives sensor data, according to an embodiment. Sensor data may be received from a variety of sources in one or more sensor networks (e.g., sensor network 218).

At operation 606, process 600 determines if the sensor data is associated with fire sensor data or medical sensor data, according to an embodiment. If neither, operation 606 proceeds to operation 607, according to an embodiment. If the sensor data is related to fire sensor data or medical sensor data, operation 606 proceeds to operation 608, according to an embodiment.

At operation 607, process 600 waits (e.g., 5 seconds, or another predetermined period of time), according to an embodiment. In one embodiment, process 600 waits until an event (e.g., incoming data). Operation 607 proceeds to operation 609, according to an embodiment.

At operation 609, process 600 determines if new sensor data has been received. If new sensor data has not been received, operation 609 may return to operation 607. If new sensor data has been received, operation 609 proceeds to operation 604, according to an embodiment.

At operation 608, process 600 validates an address received from the sensor data, according to an embodiment. Validating an address may include performing one or more operations from process 400, according to an embodiment.

At operation 610, process 600 queries a database for station ID based on the validated address, according to an embodiment. The queried database may be one that has stations associated with jurisdictional boundaries, which may be queried to determine which station and which station ID a notification should be directed toward, according to an embodiment.

At operation 612, process 600 pushes a notification of sensor activation to an emergency responder application, according to an embodiment. The notification of sensor activation may not rise to a level of emergency response request but may be used to simply notify a fire station, firefighters, or emergency medical services that a fire alarm or smoke sensor has been triggered or activated, according to an embodiment. In one embodiment, sensor alerts in the emergency responder application are notifications of a sensor activation and are not emergency response requests. Based on the alert, emergency responders may tentatively begin preparing for an emergency response request (from one or more channels) from an ECC, for example. If the sensor alert is further validated with data from a 911 call (e.g., supplemental call data), the sensor alert may be updated to indicate that a nearby (proximate) 911 call has been made that may be associated with the sensor activation, according to an embodiment. The sensor alert may still be a notification of a potential incident rather than a request for emergency services, but the additional information may enable first responders to begin preparing for a potential dispatch to a particular area, for example.

At operation 614, process 600 determines if supplemental call data has been received, according to an embodiment. If supplemental call data has not been received, operation 614 proceeds to operation 607 (which proceeds to operation 609), according to an embodiment. If supplemental call data has been received, operation 614 proceeds to operation 616, according to an embodiment.

At operation 616, process 600 confirms the address from the sensor data is proximate to an address from the supplemental call data, according to an embodiment. If the general location of the sensor data and the supplemental call data are proximate to each other (e.g., 500 m or less), process 600 may associate the sensor data with the supplemental call data and use the supplemental call data as validation or verification that the sensor data is not anomalous, according to an embodiment.

At operation 618, process 600 updates the initial notification with emergency call confirmation, according to an embodiment. The update with emergency call confirmation may include a brief message such as a nearby 911 call, an icon representing a call, text that indicates a nearby call, or the like, according to an embodiment. The single-channel alert that is based on the sensor data may be updated to become a combined alert that is representative of multiple channels (a sensor network channel and an emergency call channel), for example.

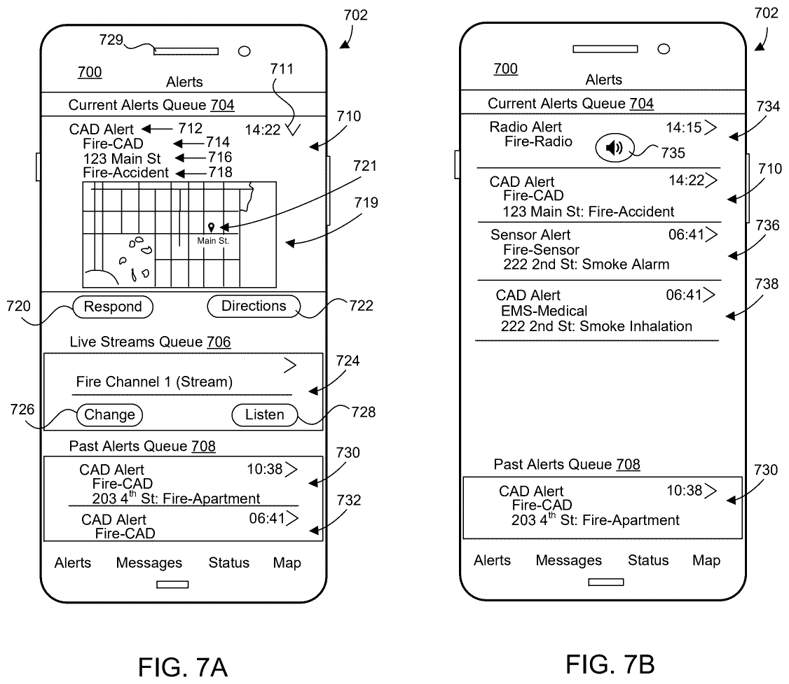

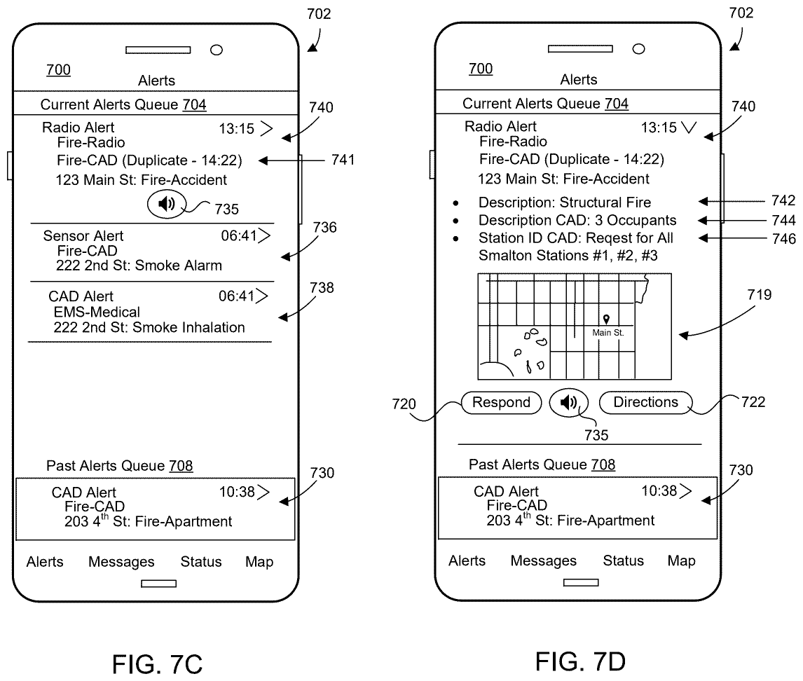

FIGS. 7A, 7B, 7C, and 7D illustrate example diagrams of UI (e.g., UI 331 shown in FIG. 3) features that an emergency responder application may provide to emergency responder devices, in accordance with aspects of the disclosure. FIG. 7A illustrates a UI 700 of an emergency responder application (e.g., emergency responder application 106 shown in FIG. 1) that may be operated by an electronic device 702 (e.g., a phone, watch, vehicle in-dash device, tablet, laptop, electronic board, etc.). UI 700 includes a current alerts queue 704, a live streams queue 706, and a past alerts queue 708.

Current alerts queue 704 includes a request alert 710, for example. Request alert 710 includes an alert title 712, an alert type 714, an address 716, an alert description 718, and a map 719 for the incident, according to an embodiment. Alert title 712 may include an indication of the source of the alert (e.g., CAD, radio, sensor, etc.), for example. Alert type 714 may indicate the type of emergency response being requested (e.g., fire, EMT/EMS, etc.). Address 716 may include a brief description of the address (e.g., the street number and street name). Alert description 718 may include brief additional information about the nature of the incident (e.g., structural fire, wires down, trapped residents, etc.). Map 719 may provide a visual representation of the location of the incident and may include a marker 721 for address 716 located within map 719, according to an embodiment. Request alert 710 is illustrated in an expanded view, but may be collapsed using, for example, a UI element 711, according to an embodiment.

Request alert 710 may include user interface elements that enable first responders to interact with UI 700. For example, request alert 710 may include a respond button 720 and a directions button 722, according to an embodiment. Respond button 720, if selected, may provide a message to the originating CAD system at the ECC that the emergency responder is responding to request alert 710. Directions button 722 may, if selected, provide text-based directions to address 716 from, for example, a user's present/current location, according to an embodiment.

Live streams queue 706 may include a number of live streams that a user may listen to, according to an embodiment. Live streams queue 706 includes a live stream 724 (e.g., for fire channel 1), according to an embodiment. Live stream 724 may include a description of the stream that may be listened to. Live stream 724 includes a change button 726 and a listen button 728, according to an embodiment. If selected, the change button 726 enables a user to change the channel of the stream that is available for listening. If selected, listen button 728 broadcasts audio for the particular selected channel on, for example, speaker 729, according to an embodiment. Although the particular UI element of a button is described and illustrated, it is to be understood that other UI elements (e.g., drop down menu, sliders, checkboxes, toggles, etc.) may be used to control UI 700, in accordance with aspects of the disclosure.

Past alerts queue 708 may include one or more request alerts that were previously provided to the emergency responder application and that were addressed and/or archived, according to an embodiment. Past alerts queue 708 includes request alert 730 and request alert 732 as example past alerts.

FIG. 7B illustrates a number of request alerts in current alerts queue 704, according to an embodiment. Some of the request alerts include duplicative emergency response requests and request alerts for different types of services for different types of emergency response requests, according to an embodiment. Current alerts queue 704 includes request alert 734, request alert 710, request alert 736 (e.g., a sensor alert), and request alert 738 (e.g., a CAD alert for emergency medical services request), as an example. Request alert 734 is a radio request that includes an alert title “radio alert”, an alert type “fire-radio”, and an audio button 735 that enables a user to play a recording of a radio-based dispatch for request alert 734, according to an embodiment. Request alert 734 may have audio that is transcribed to generate a validated address and may be updated to include the validated address, according to an embodiment. If audio quality is insufficient for transcription, request alert 734 may default to providing access to a recording of the audio without a transcribed address, for example. Request alert 710 is a CAD duplicate of a radio-based emergency response request and is time stamped with a time that is proximate to or within a window (e.g., a 30-minute window) of request alert 734. If the addresses are compared and determined to be the same (or similar), if the nature of the incident is determined to be the same (e.g., a fire), and if the time of the emergency response requests are temporally proximate to each other (e.g., within 30 minutes), the emergency management system may deduplicate and merge/combine the two request alerts into a combined (multi-channel) alert (while omitting a second audible, visual, or tactile notification of the duplicate emergency response requests).

FIG. 7C illustrates a combined request alert 740 that is an example of a combined alert or combined multi-channel request that includes information from response alert 734 and response alert 710, according to an embodiment. As illustrated, response alert 740 may include audio recording audio button 735 from response request alert 734 and may include a multi-channel identifier 741 that indicates that request alert 740 has been deduplicated and that an emergency response request has been received over multiple channels, according to an embodiment.

FIG. 7D illustrates an example diagram of an expanded view of combined request alert 740 that may include a first channel description 742 and a second channel description 744. Second channel description 744 includes information from the second channel that was not received by the first channel. Request alert 740 may also include station information 746 that is a combination of station information from the first (channel) request alert and the second (channel) request alert, according to an embodiment. Advantageously, deduplicating emergency response requests reduces potentially dangerous distractions for emergency responders who are enroute or who are preparing to respond to emergency. Deduplicating the emergency response requests also provides valuable additional information that is consolidated for the convenience of an emergency responder, which may reduce the time it takes to find important information, increase awareness about the incident, and thereby decrease the overall incident response time.

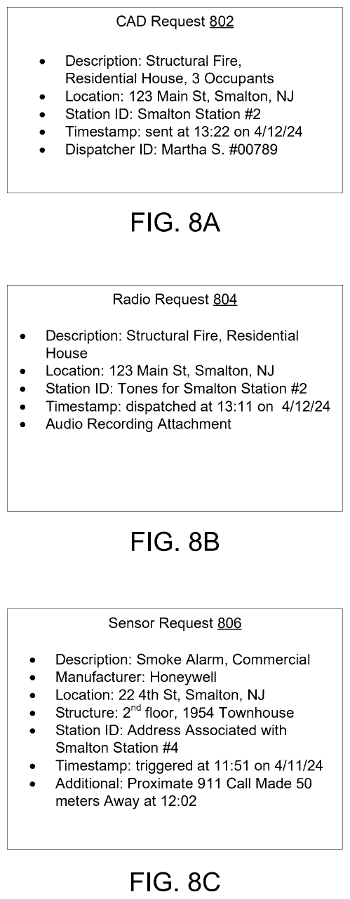

FIGS. 8A, 8B, and 8C illustrate example diagrams of records of different types of emergency response requests that may be provided (e.g., pushed) to emergency responder application to enable display of alerts, in accordance with aspects of the disclosure. FIG. 8A illustrates an example diagram of a record for a CAD request 802. A record may be stored in a database and may be at least partially pushed to the emergency responder application (app) on an emergency responder device as part of a request alert in a current request queue. CAD request 802 may include a number of fields, such as a description, a location, a station ID, a timestamp, and/or a dispatcher ID. CAD request 802 may include additional or fewer fields. FIG. 8B illustrates an example diagram of a record for a radio request 804. Radio request 804 may include a number of fields, such as a description, a location, a station ID, a timestamp, and/or an audio recording attachment. One or more fields in the radio request 804 may be populated with a transcription of the audio data. Radio request 804 may include additional or fewer fields. FIG. 8C illustrates an example diagram of a record for a sensor notification 806. Sensor notification 806 may include a number of fields, such as a description, a sensor manufacturer, a location, structure information, a station ID, a timestamp, and/or additional details. Sensor notification 806 may include additional or fewer fields.

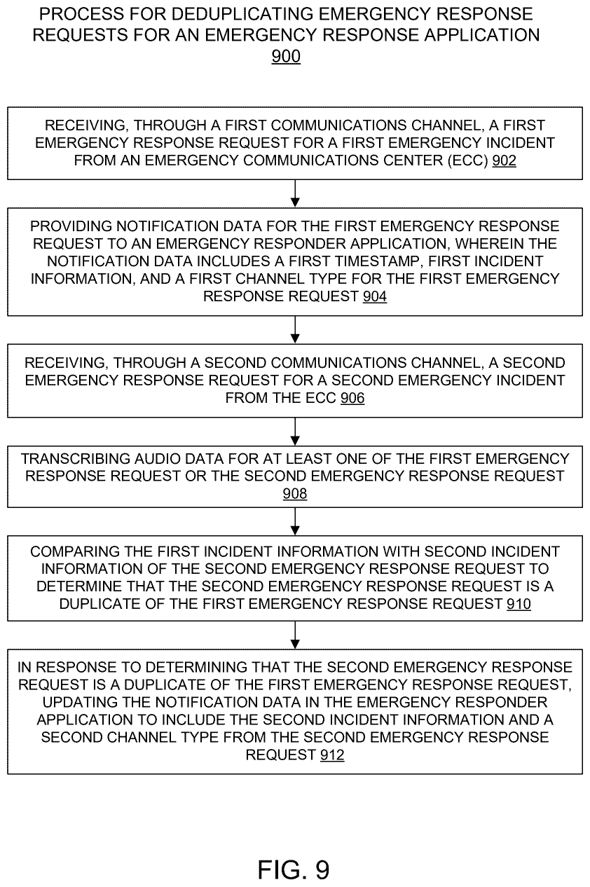

FIG. 9 illustrates a flow diagram of a process 900 for deduplicating emergency response requests for an emergency response application, in accordance with aspects of the disclosure. The order in which some or all of the process operation blocks appear in process 900 should not be deemed limiting. Rather, one of ordinary skill in the art having the benefit of the present disclosure will understand that some of the process blocks may be executed in a variety of orders not illustrated, or even in parallel. The operations of process 900 may be performed by a particular module or may be distributed between various subsystems or modules in an EMS, according to various embodiments.

At operation 902, process 902 includes receiving, through a first communications channel, a first emergency response request for a first emergency incident from an emergency communications center (ECC), according to an embodiment. The first communications channel may at least partially include a UHF or VHF radio communication path.

At operation 904, process 904 includes providing notification data for the first emergency response request to an emergency responder application, wherein the notification data includes a first timestamp, first incident information, and a first channel type for the first emergency response request, according to an embodiment.

At operation 906, process 906 includes receiving, through a second communications channel, a second emergency response request for a second emergency incident from the ECC, according to an embodiment.

At operation 908, process 908 includes transcribing audio data for at least one of the first emergency response request or the second emergency response request, according to an embodiment. In one embodiment, transcribing audio data includes identifying an address in the audio data. In one embodiment, identifying the address in the audio data includes: searching a transcription of the audio data for a key term that is associated with addresses, defining a potential address as up to 5 words prior to (or subsequent to) the key term, applying the potential address to an address verification service, and defining the address to be the potential address after the address verification service validates the potential address.

At operation 910, process 910 includes comparing the first incident information with second incident information of the second emergency response request to determine that the second emergency response request is a duplicate of the first emergency response request, according to an embodiment.

At operation 912, process 912 includes in response to determining that the second emergency response request is a duplicate of the first emergency response request, updating the notification data to the emergency responder application to include the second incident information and a second channel type from the second emergency response request, according to an embodiment.

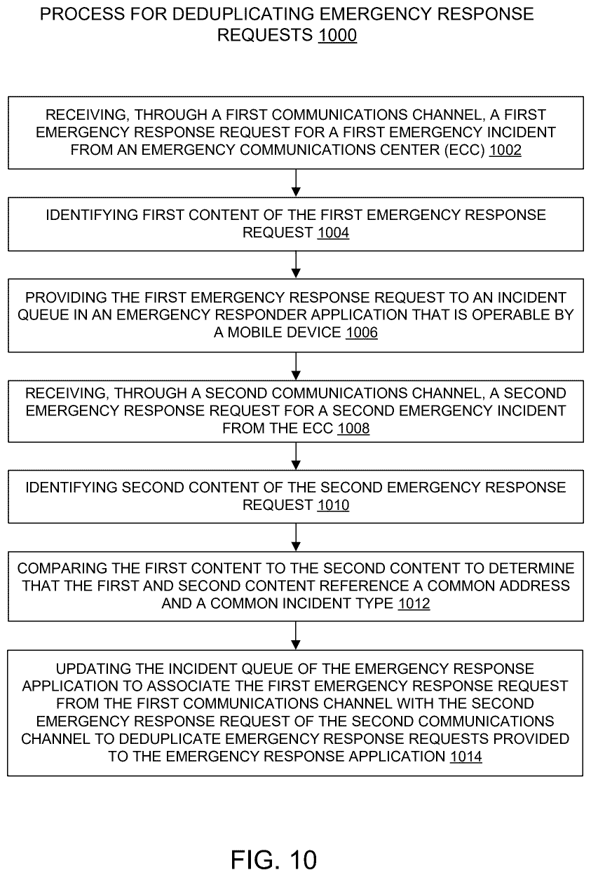

FIG. 10 illustrates a flow diagram of a process 1000 for deduplicating emergency response requests for an emergency response application, in accordance with aspects of the disclosure. The order in which some or all of the process operation blocks appear in process 1000 should not be deemed limiting. Rather, one of ordinary skill in the art having the benefit of the present disclosure will understand that some of the process blocks may be executed in a variety of orders not illustrated, or even in parallel. The operations of process 1000 may be performed by a particular module or may be distributed between various subsystems or modules in an EMS, according to various embodiments.

At operation 1002, process 1002 includes receiving, through a first communications channel, a first emergency response request for a first emergency incident from an emergency communications center (ECC), according to an embodiment.

At operation 1004, process 1004 includes identifying first content of the first emergency response request, according to an embodiment.

At operation 1006, process 1006 includes providing the first emergency response request to an incident queue in an emergency responder application that is operable by a mobile device, according to an embodiment.

At operation 1008, process 1008 includes receiving, through a second communications channel, a second emergency response request for a second emergency incident from the ECC, according to an embodiment.

At operation 1010, process 1010 includes identifying second content of the second emergency response request, according to an embodiment.

At operation 1012, process 1012 includes comparing the first content to the second content to determine that the first and second content reference a common address and a common incident type, according to an embodiment.

At operation 1014, process 1014 includes updating the incident queue of the emergency response application to associate the first emergency response request from the first communications channel with the second emergency response request of the second communications channel to deduplicate emergency response requests provided to the emergency response application, according to an embodiment.

FIG. 11 illustrates a flow diagram of a process 1100 for performing error correction of audio data transcriptions using multi-channel emergency response requests, in accordance with aspects of the disclosure. The order in which some or all of the process operation blocks appear in process 1100 should not be deemed limiting. Rather, one of ordinary skill in the art having the benefit of the present disclosure will understand that some of the process blocks may be executed in a variety of orders not illustrated, or even in parallel. The operations of process 1100 may be performed by a particular module or may be distributed between various subsystems or modules in an EMS, according to various embodiments.

At operation 1102, process 1100 receives audio data within radio incident data, according to an embodiment.

At operation 1104, process 1100 determines the quality of the audio data, according to an embodiment. Audio sent over radio from a dispatcher at an ECC may include static, the audio may break up, at times, or the audio may otherwise be garbled-due to distance, obstacles, and/or other types of interference associated with radio waves. Process 1100 may include applying the audio data to one or more machine learning models or AI models that have been trained on clear audio data and on static-infused and/or garbled audio to determine a quality (e.g., acceptable or poor) of an audio sample. If the audio quality of the audio data is poor (e.g., includes heavy static or includes intermittent/broken transmission) operation 1104 proceeds to operation 1106, according to an embodiment. If the quality of the audio data is acceptable, operation 1104 proceeds to operation 1108, according to an embodiment.

At operation 1106, process 1100 does not combine multi-channel emergency response requests because, in part, the contents from the audio data cannot be adequately compared to the contents of incident data received from a CAD system, for example. Operation 1106 proceeds to operation 1107 where process 1100 ends, according to an embodiment.

At operation 1108, process 1100 determines a first address from a transcription of the audio data, according to an embodiment. The address may include a street number, a street name, a city, and a state, according to an embodiment. In one embodiment, the first address is identified from the transcription of the audio data by searching for the term “address”, “location”, or “at” and capturing the 3-5 subsequent words, according to an embodiment. The captured potential address may be applied to one or more address verification services, and the address that is returned as verified and is determined to be in proximity to the fire station or EMS station may be selected as the first address for the dispatched incident.

At operation 1110, process 1100 receives a second address from CAD incident data, according to an embodiment.

At operation 1112, process 1100 compares the first address to the second address to determine whether the addresses are the same address, according to an embodiment. If the addresses are the same, operation 1112 proceeds to operation 1114, according to an embodiment. If the addresses are different, operation 1112 proceeds to operation 1116, according to an embodiment.

At operation 1114, process 1100 proceeds to deduplicate the requests (e.g., using one or more operations of process 302 shown in FIG. 3) associated with the radio incident data and the CAD incident data, according to an embodiment. Operation 1114 proceeds to operation 1107 where process 1100 ends, according to an embodiment.

At operation 1116, process 1100 determines if the street number and the street name are both different or if the street number or the street name are common between the first and second address, according to an embodiment. If the street name and the street number are both different, process 1100 proceeds to operation 1118, according to an embodiment. If one of the street number or the street name are the same between the first address and the second address, operation 1116 proceeds to operation 1122, according to an embodiment.

At operation 1118, process 1100 identifies the radio incident as being a different incident from the CAD incident-identifying the incidents as different incidents, according to an embodiment.

At operation 1120, process 1100 provides data for two different data for requests to the emergency responder application, according to an embodiment. One of the data for requests is associated with the radio incident data, and the second data for requests is associated with the CAD incident data, according to an embodiment. Operation 1120 proceeds to operation 1107 where process 1100 ends, according to an embodiment.

At operation 1122, process 1100 updates the first address with the second address, according to an embodiment. The CAD incident data is digital data that is input into and received from a CAD system and may generally be considered to be more reliable than an audio transcription. Thus, if a discrepancy is identified between a transcription of an audio recording and digital data, the digital data may be favored as more reliable, in some implementations. Performing error correction of an audio data transcription in this matter may provide validation of radio transcriptions and may concurrently provide error correction of audio transcriptions, which may improve the quality of deduplication of multi-channel requests, in accordance with aspects of the disclosure.

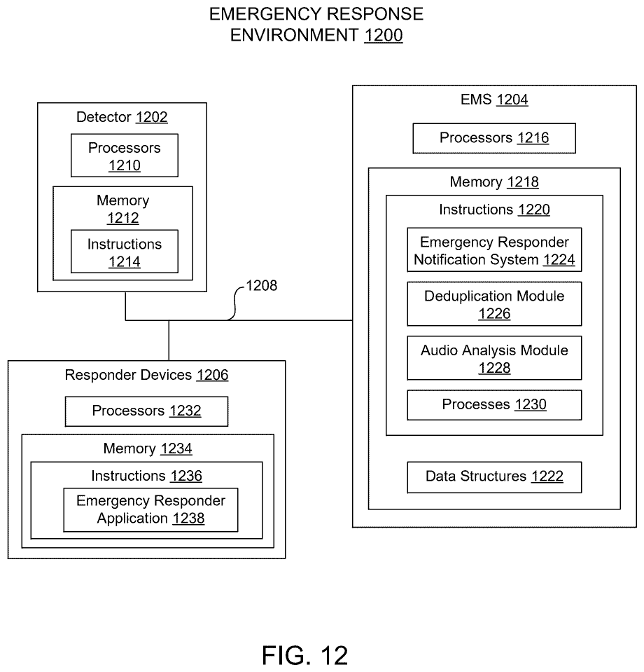

FIG. 12 illustrates an example diagram of an emergency response environment 1200, in accordance with aspects of the disclosure. Emergency response environment 1200 includes processing logic, (computer-readable) instructions, and data structures that may be employed by a detector 1202, an emergency management system (EMS) 1204, and responder devices 1206, according to an embodiment. Detector 1202, EMS 1204, and responder devices 1206 may be communicatively coupled to each other through one or more communication channels 1208 (e.g., networks, wired or wireless networks, Internet, intranet, etc.), according to an embodiment.

Detector 1202 is an example implementation of detector 170 (shown in FIG. 1), according to an embodiment. Detector 1202 may include one or more processors 1210 and memory 1212. Memory 1212 may include volatile and/or non-volatile memory. Memory 1212 may store instructions 1214 that may be executed by processors 1210, according to an embodiment.

EMS 1204 may include processors 1216, memory 1218, and data structures 1222, according to an embodiment. Memory 1218 may include instructions 1220 and data structures 1222, according to an embodiment. Memory 1218 may include volatile and/or non-volatile memory. Instructions 1220 may be stored by memory 1218 and may include an emergency responder notification system 1224, a deduplication module 1226, an audio analysis module 1228, and one or more processes 1230, according to embodiments of the disclosure. Data structures 1222 may store one or more databases used within one or more of the disclosed emergency response environments and/or emergency management systems, according to an embodiment.

Responder devices 1206 include processors 1232 and memory 1234, according to an embodiment. Memory 1234 may include instructions 1236, and instructions 1236 may include an emergency responder application 1238. Emergency responder application 1238 is representative of emergency responder application 106 (shown in FIG. 1), according to an embodiment.

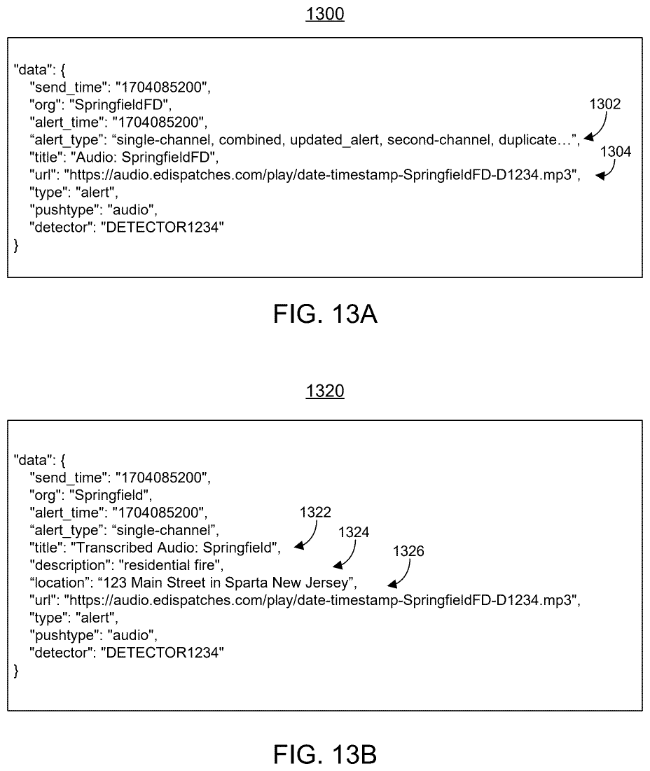

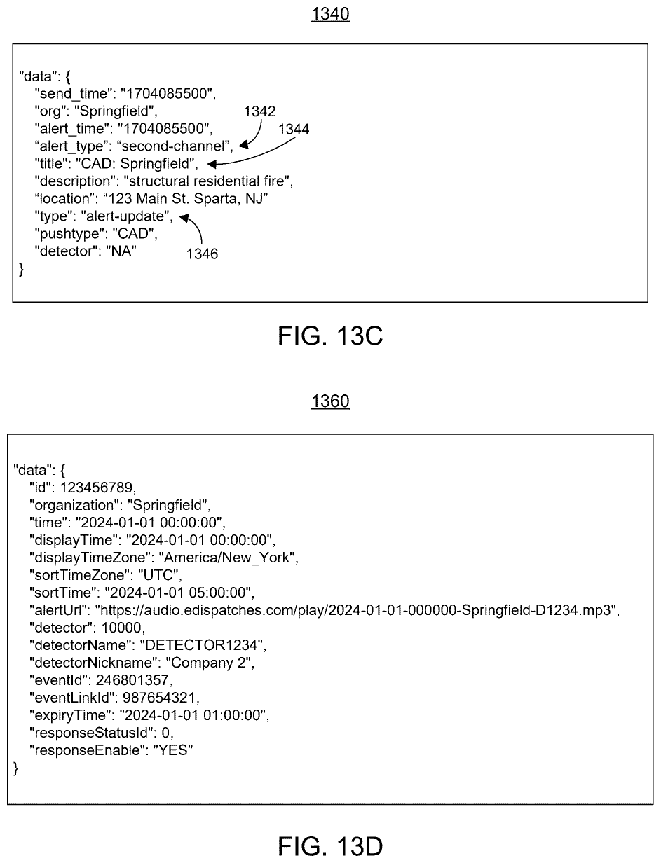

FIGS. 13A, 13B, 13C, and 13D illustrate example diagrams of data payloads that may be used to communicate alert information and updates to a first responder application, in accordance with embodiments of the disclosure. FIG. 13A illustrates a diagram of data payload 1300 that may be used to transmit a radio-based request, a CAD-based request, an alarm notification, and/or an alarm request to an emergency responder application, in response to receipt of radio incident data or CAD incident data that includes an emergency services request (or in response to receipt of sensor data), according to an embodiment. Data payload 1300 is illustrated in a JSON format, but other formats may also be used to transmit data. Data payload 1300 illustrates a number of example keys (or object names) paired with corresponding values that may be used by the emergency responder application to populate and display alerts and alert information. Data payload 1300 may include a key: value pair 1302 that includes a key of “alert_type” that may include a value that indicates one of a number of predetermined values. Example values may indicate whether the data is associated with a single-channel request, a combined request, an updated alert, a secondary-channel validation of an alert, and/or a duplicate request, for example. Other key: value pairs provide additional information that may be used and/or displayed by the emergency responder application (e.g., shown in FIGS. 7A-7D) as one or more alerts. Data payload 1300 may also include a key: value pair 1304 that includes a universal resource locator (URL) to a recording of the audio data to enable the emergency response application to replay a recording of a radio-based dispatch.

FIG. 13B illustrates a diagram of data payload 1320 that may be used to transmit a radio-based request or a CAD-based request to an emergency responder application, according to an embodiment. Data payload 1320 may be transmitted by an emergency management system to a first responder application on a first responder device, in response to receipt of radio incident data that includes an emergency services request. Data payload 1320 illustrates example key: value pairs that may be included in a payload after audio data has been transcribed to identify a description and a location of an emergency incident, according to an embodiment. Key: value pair 1322 may include a value that indicates that audio data has been transcribed (e.g., “Transcribed Audio”). Key: value pair 1324 may include a key that provides a description of an incident and may include a value that at least partially describes the incident. Key: value pair 1326 may include a key that provides a location of an incident and may include a value having at least part of a street address or location description.

FIG. 13C illustrates a diagram of data payload 1340 that may be used to transmit a CAD-based request (or a second-channel verification of a primary request) to an emergency responder application, according to an embodiment. Data payload 1340 may be transmitted by an emergency management system to a first responder application on a first responder device, in response to receipt of radio incident data or CAD incident data that includes an emergency services request. Data payload 1340 may include a key: value pair 1342, a key: value pair 1344, and a key: value pair 1346 for updating an alert with second-channel verification of an emergency services request, according to an embodiment. Key: value pair 1342 may include a value that indicates that the data is associated with a second-channel verification of an existing alert, which allows the emergency responder application to update a GUI to reflect second-channel verification, according to an embodiment. Key: value pair 1344 may include a value that indicates that the data is associated with a CAD-based request (e.g., “CAD: . . . ”). Key: value pair 1346 may include a value that indicates that the type of alert is an update to an existing alert. An example of the value is “alert-update”, according to an embodiment.

Payload data 1300, 1320, and 1340 are examples of payloads that may be sent to a first responder application from an emergency management system. Each of the payloads may initially be sent to a third-party server (e.g., a telecommunications server, a smartphone manufacturer server associated with the recipient device, or an operating system (OS) server associated with an OS operated on the recipient device), and the third-party server may forward the payload to an application that may have been installed from a mobile app marketplace (e.g., Apple App Store, Google Play Store, etc.), according to embodiments of the disclosure. The emergency responder application may include information requests that are fulfilled by a request to, for example, the emergency management system (without going through the third-party store).

FIG. 13D illustrates a diagram of payload data 1360 that may be transmitted to a mobile electronic device, in response to a request from the emergency responder application. In one embodiment, payload data 1360 is transmitted to the emergency response application, in response to additional information being requested by the emergency response application. Payload data 1360 may include information that has been deduplicated, may include additional information about combined alerts, may include information about the second-channel verification of an initially received emergency response request.

While this disclosure contains many specific implementation details, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

The term “logic” and/or “processing logic” in this disclosure may include one or more processors, microprocessors, multi-core processors, application-specific integrated circuits (ASIC), and/or field programmable gate arrays (FPGAs) to execute operations disclosed herein. In some embodiments, memory may be integrated into the logic to store instructions to execute operations and/or store data. Logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application-specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of deduplicating emergency response requests, comprising:
receiving, through a first communications channel, a first emergency response request for a first emergency incident from an emergency communications center (ECC);
providing notification data for the first emergency response request to an emergency responder application, wherein the notification data includes a timestamp, first incident information, and a first channel type for the first emergency response request;
receiving, through a second communications channel, a second emergency response request for a second emergency incident from the ECC;
transcribing audio data for at least one of the first emergency response request or the second emergency response request to generate at least part of the first incident information or at least part of second incident information of the second emergency response request;
comparing the first incident information with the second incident information to determine that the second emergency response request is a duplicate of the first emergency response request through the second channel; and
in response to determining that the second emergency response request is a duplicate of the first emergency response request, updating the notification data in the emergency responder application to include a second channel type to provide multi-channel validation of the first incident information.

2. The method of claim 1, wherein the first communications channel or the second communications channel at least partially includes a radio communications channel, wherein the radio communications channel includes at least one of very-high frequency (VHF) or ultra-high frequency (UHF) transmissions.

3. The method of claim 1, wherein transcribing the audio data includes applying the audio data to a machine learning model, a speech-to-text service, or an artificial intelligence (AI) model, wherein the method further comprises:
identifying incident information from an audio data transcription, wherein the incident information includes an address and an incident type, wherein the incident information is the first incident information or the second incident information.

4. The method of claim 3, further comprising:
searching the audio data transcription for a key term that is associated with addresses;
defining a potential address as up to 5 words subsequent to the key term;
applying the potential address to an address verification service; and
defining the address to be the potential address after the address verification service validates the potential address.

5. The method of claim 3, further comprising:
providing a prompt to the AI model or the transcription service to identify the address from the audio data or from the transcribed audio data;
defining results from the AI model or the transcription service for the prompt as a potential address;
applying the potential address to an address verification service;
defining the address to be the potential address after the address verification service validates the potential address.

6. The method of claim 3, further comprising:
providing instructions to the emergency responder application to display the address and the incident type as an alert in a user interface (UI) for the emergency responder application.

7. The method of claim 1, wherein updating the notification data includes providing silencing audible alert notifications on the emergency responder application to reduce a likelihood of distracting a user of the emergency responder application.

8. The method of claim 1, wherein the first communications channel is a radio-based channel and the second communications channel is a computer aided dispatch (CAD)-based channel, the method further comprising:
wherein the first incident information includes a first address and a first incident type, wherein the first address and the first incident type are determined from a transcription of the audio data, wherein the audio data includes a recording of a dispatch transmitted from an ECC over the first communications channel,
wherein the second incident information includes a second address and a second incident type,
wherein comparing the first incident information with the second incident information includes comparing the first address to the second address and comparing the first incident type to the second incident type.

9. The method of claim 8, wherein updating the notification data includes:
performing error correction of the first address based on the second address,
wherein the first address includes a first street number and a first street name,
wherein the second address includes a second street number and a second street name,
wherein comparing the first address to the second address includes comparing the first street number to the second street number,
wherein performing error correction includes updating the first street number to match the second number after determining that the first street name matches the second street name.

10. The method of claim 8, wherein updating the notification data includes:
performing error correction of the first address based on the second address,
wherein the first address includes a first street number and a first street name,
wherein the second address includes a second street number and a second street name,
wherein comparing the first address to the second address includes comparing the first street name to the second street name,
wherein performing error correction includes updating the first street name to match the second street name after determining that the first street number matches the second street number.

11. An emergency response request notification system, comprising:
a radio scanner operable to receive radio communications over a first communications channel from an emergency communications center (ECC);
a detector coupled to the radio scanner and operable to record at least part of the radio communications to generate audio data; and
a server communicatively coupled to the detector, the server being operable to:
receive the audio data from the detector, wherein the audio data at least partially includes a dispatch of a first emergency response request from the ECC;
identify a first address and a first emergency type for the first emergency response request from the audio data;
provide the first address, the first emergency type, and a first channel type to an emergency responder application to cause the emergency responder application to display a request alert in a user interface (UI);
receive a second emergency response request from a second communications channel that includes a computer-aided dispatch (CAD) system from the ECC, wherein the second emergency response request includes a second address and a second emergency type;
compare the first address to the second address and the first emergency type to the second emergency type;
associate the second emergency response request with the first emergency response request to deduplicate the first and second emergency response requests; and
provide instructions to the emergency responder application to update the request alert to include the second channel type as an indication of validation of the first emergency response request over the first channel type.

12. The emergency response request notification system of claim 11, wherein the server is further operable to:
apply the audio data to an artificial intelligence (AI) model;
provide a prompt to the AI model to identify address content as a potential first address; and
provide a prompt to the AI model to identify a nature of an emergency in the audio data to identify the first emergency type.

13. The emergency response request notification system of claim 12, wherein the server is further operable to:
provide historical dispatch transcriptions of a plurality of ECCs to the AI model; and
provide instructions to the AI model to train on the historical dispatch transcriptions.

14. The emergency response request notification system 12, wherein the server is further operable to:
apply the potential first address to a verification service; and
based on address validation from the verification service, define the potential address as the first address.

15. The method of claim 11, wherein the server is further operable to:
apply the audio data to a transcription service to generate a transcription of the audio data;
search the transcription for a key term that is associated with addresses;
define a potential address as 5 words prior to the key term;
apply the potential address to an address verification service; and
define the first address as the potential address in response to validation of the potential address by the address verification service.

16. A method of deduplicating emergency response requests for an emergency responder application, comprising:
receiving, through a first communications channel, a first emergency response request for a first emergency incident from an emergency communications center (ECC);
providing the first emergency response request to an incident queue in an emergency responder application for display as an emergency response request alert on a mobile device;
receiving, through a second communications channel, a second emergency response request for a second emergency incident from the ECC;
comparing a first address of the first emergency response request to a second address of the second emergency response request to determine that the first and second emergency response requests reference a common address;
comparing timestamp data of the first and second emergency response requests to determine that the first and second emergency response requests were received within a predetermined period of time; and
updating the incident queue of the emergency response application to combine characteristics of the second emergency response request with the emergency response request alert displayed by the mobile device to deduplicate the first and second emergency response requests provided by the ECC.

17. The method of claim 16, further comprising:
recording the first emergency response request to generate audio data responsive to a radio dispatch from the ECC, wherein the first communications channel at least partially includes a very-high frequency (VHF) or ultra-high frequency (UHF) transmission;
applying the audio data to a transcription service to extract the first address, wherein the first address includes a first street number and a first street name, wherein the second address includes a second street number and a second street name; and
performing error correction of the first address by replacing the first street name with the second street name or by replacing the first street number with the second street number when the first and second street names do not match or when the first and second street numbers do not match.

18. The method of claim 16, further comprising:
receiving a third emergency response request from the ECC; and
providing the third emergency response request to the emergency responder application to display a third emergency response request alert on the mobile device.

19. The method of claim 16, further comprising:
receiving sensor data from a sensor network, wherein the sensor data includes a sensor address and a sensor type;
determining that the sensor type includes a medical incident or a fire-related incident;
providing at least part of the sensor data to the emergency responder application to display a sensor alert on the mobile device.

20. The method of claim 19, further comprising:
receiving supplemental call data indicative of initiation of a 911 call by a second mobile device, wherein the supplemental call data includes location data;
comparing the location data to the sensor address to determine that the second mobile device is within 500 meters of the sensor address; and
providing instructions to the emergency responder application to update the sensor alert with an indication of a 911 call associated with the sensor data.
